(19) United States
(12) Patent Application Publication
(10) Pub. No.: US 2010/0067711 A1
(43) Pub. Date: Mar. 18, 2010

(54) METHOD AND SYSTEM FOR MANUFACTURING A HEARING DEVICE WITH A CUSTOMIZED FEATURE SET

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/521,794

(22) PCT Filed: Jan. 15, 2007
(86) PCT No.: PCT/EP2007/050326

§ 371 Date: Jun. 30, 2009

(51) Int. Cl. H04R 25/00; H04R 29/00; G06F 9/445; G06F 9/45; G06F 9/44

(52) U.S. Cl. 381/60; 381/314; 717/174; 717/140; 717/165; 382/100

(57) ABSTRACT

The method for manufacturing a hearing device, which hearing device includes at least one programmable processor, includes the steps of a) providing a set of software members, b) selecting a subset of said set, and c) creating an image of said subset, which is executable in said at least one processor. This allows to select from a large set of software members only those, which are suitable for a specific user. The system for manufacturing a hearing device in dependence of individual preferences of a user of said hearing device, which hearing device includes at least one programmable processor, includes a selecting tool allowing to select a subset of software members from a set of software members, and a build tool for creating an image of said subset of software members, wherein said image is executable in said at least one processor.

### TECHNICAL FIELD

The invention relates to the field of hearing devices and in particular to the manufacture of programmable hearing devices. It relates to methods and systems according to the opening clauses of the claims.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

### BACKGROUND OF THE INVENTION

Most modern hearing devices comprise at least one digital signal processor, which is programmable for carrying out audio signal processing features and/or for providing usability features. A feature can be considered a functionality. Usually, many different audio signal processing features are available, such as classification of input audio signals, noise suppression, beam forming, automatic gain adjustments in dependence of an input level. Usability features comprise, e.g., controlling the output volume or other parameters by means of user-manipulable controls at the hearing device or at a remote control associated with the hearing device, or automatic volume adjustments in dependence of past manual volume adjustments, or acknowledge signal to be played to the user upon events such as program or volume changes, or self-tests of hearing device components.

Today, hearing devices like hearing-aid devices are developed and distributed as different models (typically of the order of 10 to 100 per hearing device manufacturer) differing in their mechanical design and in their functional properties such as the above-mentioned audio signal processing features and usability features, so as to match the presumed preferences of large groups of hearing device users like severely hearing-impaired pediatric users or affluent adult users.

From DE 199 49 604 B4, a method for configuring the functional properties of a hearing-aid device having a programmable IC is known. In this method, a hearing-aid device is deployed in a basic version, in which the hearing-aid device manufacturer only unlocked basic features, i.e., only basic features of the hearing device are accessible, whereas more advanced features of the hearing device cannot be used. This hearing-aid device can then be upgraded to a high-end version by making additional features of the hearing device accessible, which is accomplished in a programming station to which the hearing-aid device can be connected. This unlocking of additional features of the hearing-aid device involves the use of a data carrier, which has to be connected to this programming station. Such a data carrier comprises configuration upgrade information, which is used for tracking, how many times which of said advanced features have been unlocked in hearing devices in conjunction with this data carrier, so as to ensure that an allowed number of such unlockings is not exceeded. Such data carriers are intended to be sold to hearing device professionals at prices depending on the number of allowed unlockings of advanced features.

The way of configuring the functional properties of a hearing-aid device disclosed in said DE 199 49 604 B4 has the disadvantage that any advanced feature that might at one point be used in a specific hearing-aid device has already to reside in that specific hearing-aid device.

### SUMMARY OF THE INVENTION

Therefore, one object of the invention is to create a method and a system for manufacturing a hearing device that do not have the disadvantages mentioned above. In particular, said method and said system shall allow to minimize the storage space required in a hearing device.

A method shall be provided, which allows to manufacture a hearing device with a customized feature set, in the sense that for each hearing device user, a feature set can be tailored to the individual preferences of said specific user. In addition, the respective method for manufacturing a hearing device shall be provided.

Another object of the invention is to create hearing devices, which are user-specifically equipped with signal processing features and/or usability features.

Another object of the invention is to provide for a method and system that allow to generate signal processing and/or user-interface managing software that better meets the constraints of memory size in a hearing device.

Another object of the invention is to provide for a method and system that allow to generate signal processing and/or user-interface managing software that better meets the constraints of processing power in a hearing device.

Another object of the invention is to provide for a method and system that allow to generate signal processing and/or user-interface managing software that better meets the constraints of power consumption and energy supply in a hearing device.

Further objects emerge from the description and embodiments below.

At least one of these objects is at least partially achieved by systems and methods according to the patent claims.

The method for manufacturing a hearing device, which hearing device comprises at least one programmable processor, comprises the steps of
a) providing a set of software members;
b) selecting a subset of said set;
c) creating an image of said subset, which is executable in said at least one processor.

This allows to select from a large set of software members only such software members, which are desired, namely those, which form said subset, and then create code executable in said processor of the hearing device. Thus, the hearing device does not need to have storage space for software members which are not needed in this specific hearing device.

Usually, said set of software members is provided by the hearing device manufacturer.

Typically, each of said software members of said subset and, preferably, each of said software members of said set, represents a feature implementable in said hearing device, in particular, a usability feature or a signal processing feature such as an audio signal processing feature.

In one embodiment, said set is stored in a storage device external to said hearing device. Typically, the storage space requirements of said set exceed—usually by far—the storage space available in said hearing device.

In one embodiment, the selection made in step b) is a selection according to individual preferences of a user of said hearing device. Said selecting of said subset will typically be carried out by a hearing health care professional such as a hearing device dispenser or an audiologist, considering the communication and hearing needs and preferences of the user of the hearing device. Said selecting may also be carried out by the user himself, possibly assisted by another person or by a computer program.

The creation of said image in step c) can be accomplished automatically after step b) has is finished. Typically, step c) is carried out on a computer associated with the hearing device manufacturer.

In one embodiment, at least one of said software members comprises source code. In this case, said creation of said image will usually comprise a compilation of pieces of source code.

In one embodiment, at least one of said software members comprises object code. In this case, said creation of said image will usually comprise a linking of pieces of object code.

In one embodiment, step c) comprises at least one of
c1) compiling source code comprised in at least one of said software members; and
c2) linking object code comprised in at least one of said software members and/or obtained by compiling source code comprised in at least one of said software members.

Preferably, said software members have well-defined variation points, which allow to form a multitude of combinations of software members from software members comprised in said set of software members.

A software member may be a software module or comprise at least one software module. A software member may comprise one or more chunks of software, e.g., a software member may comprise a multitude of lines of code, which lines may be fully or in part consecutive or discontinuous. Usually, a software member is non-executable, i.e., it has to undergo some processing such as compiling and/or linking before an executable file can be obtained.

In one embodiment, the method comprises the step of
d) loading said image into said hearing device.

Usually, either the hearing device manufacturer or the hearing health care professional, or even the user will load said image into the hearing device.

In one embodiment, step b) comprises the step of checking the compatibility of the software member selection with selection rules. If requirements defined in said selection rules are not met, the selection usually will be manually or automatically corrected, so that said selection rules are finally complied with. Examples for such selection rules are given below, in steps b1), b2), b3).

In one embodiment, step b) comprises the step of
b1) checking the compatibility of the selected software members among each other.

It is possible that among the software members comprised in said set of software members, some specific combinations of software members do not work. By means of step b1), an attempt to create an image comprising such incompatible software members can be avoided.

In one embodiment, step b) comprises the step of
b2) checking the completeness of the selected software members.

It is possible that among the software members comprised in said set of software members, certain software members require the presence of one or more other software members in order to function properly. Or, it is required that a minimum number of certain variants of software members has to be selected or a maximum number of certain variants of software members may not be exceeded. By means of step b2), an attempt to create an image in which required software members are missing or in which an excessive number of certain software members has been selected can be avoided.

In one embodiment, step b) comprises the step of
b3) checking the compatibility of the selected software members with resources of said hearing device.

Certain software members may require the presence of specific hardware features of the hearing device. Furthermore, said image will need certain computational resources in order to be properly executable in said processor. The latter concerns, in particular, memory requirements of the image and processing power requirements of the image.

By means of step b3), an attempt to create an image, which poses requirements such as those mentioned before, which cannot be met by the hearing device, can be avoided.

In one embodiment, a computer program is used for carrying out step b). In particular, step b) may comprise transmitting data via the internet.

In one embodiment, the method further comprises the step of
e) testing said image.

This step e) can be carried out after step d), in which case the testing can take place using the specific hearing device of the user. It is also possible to carry out step e) before step d), in which case the testing will preferably be carried out using another hearing device, which is nominally identical with the specific hearing device of the user, or using a hearing device simulator.

It is desirable to test (in step e)) the correct function of each implemented feature and/or the correct overall function of the hearing device or the hearing device simulator in which said image is used for testing. It is possible to comprise an automated assessment of sound quality in step e).

The system for manufacturing a hearing device in dependence of individual preferences of a user of said hearing device, which hearing device comprises at least one programmable processor, comprises
a selecting tool allowing to select a subset of software members from a set of software members; and
a build tool for creating an image of said subset software members, wherein said image is executable in said at least one processor.

This allows a user-specific generation of hearing device operating software. Hearing device operating software is also referred to as hearing device firmware or embedded software.

In one embodiment, said selecting tool is a selecting tool for allowing an individual to select a subset of features from a set of features.

In one embodiment, the system comprises
a storage device external to said hearing device, comprising said set of software members.

This may, e.g., be a storage device such as a hard disk or a DVD or the like, connected to a server associated with the hearing device manufacturer.

In one embodiment, the system comprises a test tool for testing said image.

In one embodiment, said build tool is operationally connectable to said hearing device for loading said image into said hearing device. Preferably, said selecting tool is operationally connectable to said build tool. And preferably, said storage device is operationally connectable to at least one of said build tool and said selecting tool.

In one embodiment, said selecting tool is adapted to at least one of checking the compatibility of the selected software members among each other;
checking the completeness of the selected software members; and
checking the compatibility of the selected software members with resources of said hearing device.

Preferably, said selecting tool is adapted to at least two of said checks, more particularly of all three.

In one embodiment, said selecting tool comprises a computer connectable to the internet and an computer program installed on said computer adapted to accessing the internet.

The advantages of the systems correspond to the advantages of corresponding methods.

Further preferred embodiments and advantages emerge from the dependent claims and the figures.

### BRIEF DESCRIPTION OF THE DRAWINGS

Below, the invention is described in more detail by means of examples and the included drawings. The figures show schematically:

FIG. 1 a diagrammatical illustration of a method according to the invention;

FIG. 2 a diagrammatical illustration of a system and a method according to the invention.

The reference symbols used in the figures and their meaning are summarized in the list of reference symbols. The described embodiments are meant as examples and shall not confine the invention.

### DETAILED DESCRIPTION OF THE INVENTION

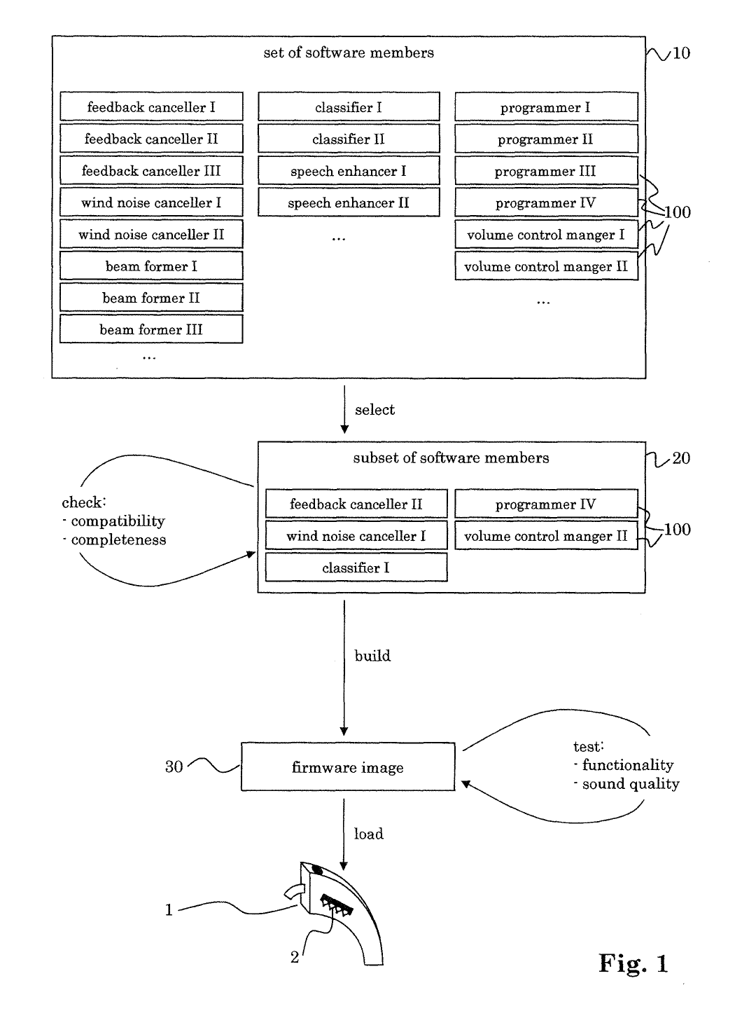

FIG. 1 shows a diagrammatical illustration of a method according to the invention. A multitude of software members 100 forms a set 10 of software members. Each software member 100 typically represents one feature of a hearing device, e.g., a feedback canceller, a classifier, a volume control manager or the like. Examples are given in FIG. 1. The software members 100 are typically stored in digital form in a storage device. Any of the software members 100 may be embodied as a chunk or portion of source code and/or—in a pre-compiled form—as a chunk or portion of object code. It is possible to store different software members 100 separately, but it is also possible to have several or even all software members 100 of the set 10 stored in one file.

Possibly, there are several software members 100 selectable for nominally the same feature, e.g., for feedback cancelling; such software members 100 may differ, e.g., in the underlying algorithm, in the achievable sound quality or effectiveness, in the storage requirements and/or in the processing power requirements.

From said set 10, a selection is made, so as to obtain a subset 20 of software members. This selection reflects the preferences of a specific hearing device user, i.e., the selected software members 100 of the subset 20 represent those features, which are expected to suit said specific user best.

The selection is checked and possibly corrected. The correction may (partially) be carried out automatically and (partially) be done manually. Properties that may be checked comprise
compatibility of the selected software members among each other;
compatibility of the selection with resources of said hearing device;
completeness of the selected software members.

More generally spoken, the compliance of the selection with selection rules is checked. To give more concrete examples, such selection rules may comprise rules like
exactly one feedback canceller has to be in the subset;
at most one wind noise canceller may be in the subset;
wind noise canceller II is incompatible with beam former III;
beam former I requires at least two microphones.

From the (finally) determined subset of software members, an image 30 is built, which is loaded into a hearing device 1 having a programmable processor 2, where said image 30 is used as the firmware or as a part thereof.

After loading the image 30 into the hearing device 1 or, as indicated in FIG. 1, before loading the image 30 into the hearing device 1, the image 30 can be tested. Testing may comprise testing each feature implemented by said image 30, testing the overall function of the image 30 and testing the sound quality achieved using the image 30.

By means of the presented method, it is possible to provide any hearing device user with a hearing device 1 having exactly those functionalities, which he desires in dependence of his specific hearing preferences and the amount of money the user or the user's health insurance wants to spend on his individualized hearing device 1.

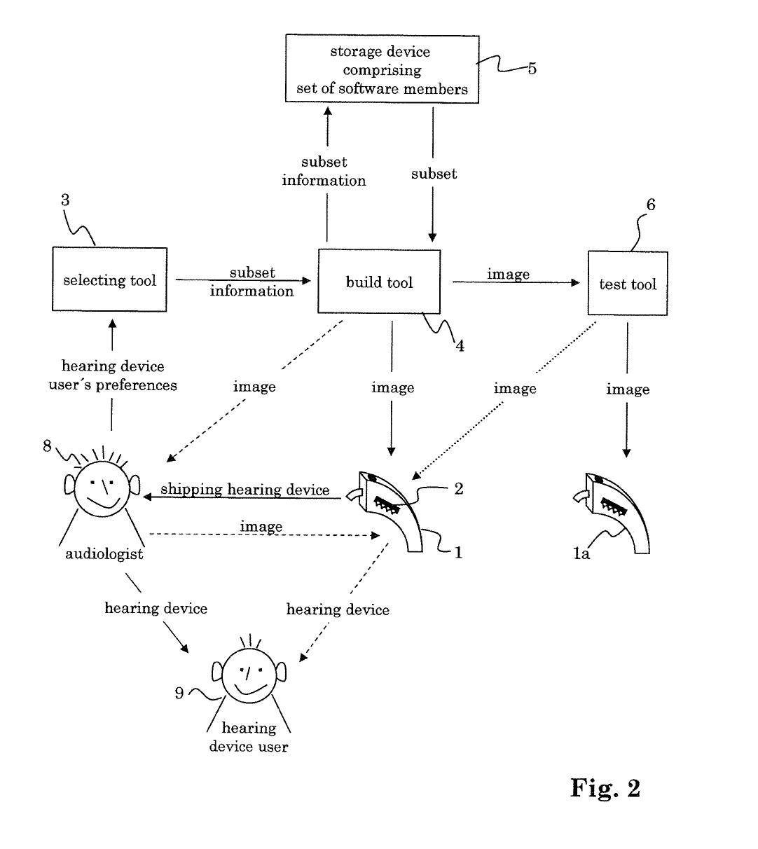

Further details are now discussed in conjunction with FIG. 2.

FIG. 2 shows a diagrammatical illustration of a system and a method according to the invention. The system comprises a selecting tool 3, a build tool 4, a storage device 5 comprising a set of software members, a test tool 6 and a testing vehicle 1a, all directly or indirectly operationally connectable to each other.

A hearing health care professional 8 who takes care of a user 9 determines, based on the hearing and communication needs of said user 9, the user's hearing device related preferences.

By means of the selecting tool 3, the hearing health care professional 8 selects—from a set of hearing device features—such hearing device features, of which he thinks that they meet the user's preferences best. The hearing health care professional 8 directly or indirectly selects software members to be implemented in the hearing device 1, namely such software members, which—when implemented in hearing device 1—will embody said features. Typically, each feature corresponds to one software member (or possibly several software members) by means of which the feature can be implemented in the hearing device 1.

Furthermore, it is also possible that said selection comprises choosing one or more “aspects”, wherein such an aspect determines more general properties of the hearing device, such as “minimized power consumption” or “optimized sound while disregarding power consumption”. The choice of such an aspect typically influences said selection of said software members, e.g., in such a way that for the selected features preferably those software members are finally selected, which agree best with the chosen aspects.

The selecting tool 3 can comprise or be a computer with a computer program displaying a user interface allowing to select features and/or software members from a large number of hearing device features and/or software members.

Various embodiments are possible. For example: said selecting tool 3 comprises a local computer with a program, not requiring any connections to elsewhere for accomplishing said selecting, wherein it is possible to foresee that said program has to be downloaded from a remote server, e.g., via the internet; or said selecting tool 3 comprises a local computer with a program for accomplishing said selection, wherein said local computer is connectable to the internet for downloading selection rules needed during said selecting process; or said selecting tool 3 comprises a local computer with an internet browser and, in addition, another computer (remote computer; server) connected to said local computer via the internet, and on said remote computer a program enabling said selecting is run.

The selecting tool 3 can be adapted to providing its user with information about costs associated with a currently or finally selected subset and/or with each selected software member or feature.

Furthermore, the selecting tool 3 can be adapted to offering pre-selected groups of features or software members.

The hearing health care professional's input to the selecting tool 3 can be checked for compatibility with selection rules, e.g., it can be checked
for the compatibility of the selected software members among each other;
for the completeness of the selected software members; and
for the compatibility of the selected software members with resources of said hearing device 1.

This checking is preferably carried out automatically by the selecting tool 3. The selecting tool 3 can automatically correct for incompleteness or incompatibilities in the hearing health care professional's input and/or request the hearing health care professional 8 for a corrected input.

Selection rules may for example be incorporated in a program used for accomplishing said selection or may be stored in a storage device, being downloadable into said program.

When a final selection of features or corresponding software members has been made, subset information is transmitted to the build tool 4, e.g., via the internet. The subset information is data related to or representative of said selection of software members, which form a subset of the offered (full) set of software members from which the selection has been made.

Accordingly, said subset information is related to or representative of a selection of hearing device features represented by the selected software members. It is possible that the selecting tool 3 indicates to its user a set of hearing device features or directly a set of software members to choose from.

Using the subset information, build tool 4 receives the subset of software members, i.e., the selected software members, from storage device 5 and creates therefrom an image which is executable in at least one processor 2 of hearing device 1. The build tool can be a server associated with the manufacturer of hearing device 1 with a suitable computer program. That computer program can be configured such that said image is created automatically upon receiving said subset information. Depending on the format of the software members in the subset, the computer program may comprise a compiler, a linker and/or a pre-processor.

The software members preferably have well-defined variation points allowing for many different combinations of software members for forming said image.

Today, many ways for creating images from parts of a base of common software members, such as chunks of source code, are known. In the field of software engineering, methods for compile-time configuration of code, i.e., the selection of a subset of program code to be included in the executable program at the time of compilation, are well known; for example, conditional compilation and the use of a pre-processor, or automatically generated makefiles, or mechanisms based on file name conventions. There are even automated tools available for instantiating program code for individual products from a common code base with well-defined variation points. One example for such a tool is called “Gears” (cf. http://biglever.com). Such tools usually include data representing knowledge about dependencies between different software members, such as: a software member A requires a software member B, or software members C and D are mutually exclusive. Data about such dependencies are valuable during compile time or already while composing said subset of software members.

In the field of software engineering, the concept of a “software product line” is defined as “a set of software-intensive systems that share a common, managed set of features satisfying the specific needs of a particular market segment and that are developed from a common set of core assets in a prescribed way” (cf. http://www.sei.cmu.edu/productlines). From that point of view, the invention can be understood as the application (or use) of software product line technology for manufacturing a hearing device having a feature set chosen in dependence of the preferences of a specific user. More information on software product lines is available at http://www.softwareproductlines.com.

Preferably, said image is tested before the hearing device user 9 receives his hearing device 1. For testing the image, the test tool 6 is used, which may be embodied as a computer-controlled machine. The image can be transferred into the testing vehicle 1a, which can be a hearing device simulator or a hearing device 1a. In the latter case, said hearing device 1a is preferably technically nominally identical with hearing device 1 of user 9. If an insufficient or faulty performance of the image is detected, the image will usually be analyzed and reworked.

After a successful test, the image is transferred into the hearing device 1 of user 9. It is possible to foresee that testing starts automatically after creation of the image. And it is also possible to foresee that testing is accomplished in an automated fashion.

Preferably, at least a part of the operating hearing device firmware is obtained by means of a method and/or a system according to the invention.

As indicated be the dotted arrow, it is also possible that the image is tested in the hearing device 1 of user 9.

As implied in the embodiment of FIG. 2, the image may be transferred into hearing device 1 by the hearing device manufacturer, whereupon hearing device 1 is shipped to the hearing health care professional 8, who then gives the hearing device 1 to its user 9.

Alternatively, as indicated by the dashed arrows, the image is transferred to the hearing health care professional 8, who then transfers it into hearing device 1 and gives the hearing device 1 to its user 9.

It is also possible that the testing and/or the image creation takes place under control of the hearing health care professional 8.

Furthermore, it is also possible that user 9 takes the position of the hearing health care professional 8. In this case, the selecting tool 3 may request from the hearing device user 9, who is operating the selecting tool, input concerning his communication needs and preferences and/or his daily life, e.g., “Do you often like to listen to music?”, “Are you frequently in noisy situations wanting to have a conversation?”, “What is more important to you: long battery life or good hearing in noisy situations?”. Based on the corresponding input, selecting tool 3 can automatically make a selection of suitable software members, i.e., the selecting tool 3 can be adapted to select said subset of software members on the basis of input it receives, e.g., from the hearing device user 9.

The invention allows to manufacture hearing devices, which are equipped to meet specific needs of specific users, in particular, wherein the hardware resources of the hearing device, in particular available memory and available processing power, are optimally used.

### LIST OF REFERENCE SYMBOLS

1 hearing device
1a testing vehicle, hearing device or hearing device simulator
2 processor
3 selecting tool, computer with computer program
4 build tool, build server, computer with computer program, compiler/linker
5 storage device, hard disk
6 test tool, test server, computer with computer program
8 hearing health care professional, audiologist
9 user, hearing device user
10 set of software members
20 subset of software members
30 image
100 software member

What is claimed is:

1. A method for manufacturing a hearing device, which hearing device comprises at least one programmable processor, said method comprising the steps of
a) providing a set of software members;
b) selecting a subset of said set;
c) creating an image of said subset, which is executable in said at least one processor.

2. The method according to claim 1, wherein the selection made in step b) is a selection according to individual preferences of a user of said hearing device.

3. The method according to claim 1, further comprising the step of:
d) loading said image into said hearing device.

4. The method according to claim 1, wherein at least one of said software members comprises source code.

5. The method according to claim 1, wherein at least one of said software members comprises object code.

6. The method according to claim 1, wherein step b) comprises the step of:
b1) checking the compatibility of the selected software members among each other.

7. The method according to claim 1, wherein step b) comprises the step of
b2) checking the completeness of the selected software members.

8. The method according to claim 1, wherein step b) comprises the step of:
b3) checking the compatibility of the selected software members with resources of said hearing device.

9. The method according to claim 1, wherein step b) comprises transmitting data via the internet.

10. The method according to claim 1, wherein step c) comprises at least one of:
c1) compiling source code comprised in at least one of said software members; and
c2) linking object code comprised in at least one of said software members and/or obtained by compiling source code comprised in at least one of said software members.

11. The method according to claim 1, further comprising the step of:
e) testing said image.

12. The method according to claim 1, wherein each of said software members of said subset represents a feature implementable in said hearing device.

13. The method according to claim 1, wherein said set is stored in a storage device external to said hearing device.

14. A system for manufacturing a hearing device in dependence of individual preferences of a user of said hearing device, which hearing device comprises at least one programmable processor, said system comprising:
a selecting tool allowing to select a subset of software members from a set of software members; and
a build tool for creating an image of said subset of software members, wherein said image is executable in said at least one processor.

15. The system according to claim 14, further comprising:
a storage device external to said hearing device, comprising said set of software members.

16. The system according to claim 14, wherein said selection is made according to said individual preferences of said user of said hearing device.

17. The system according to claim 14, further comprising:
a test tool for testing said image.

18. The system according to claim 14, wherein said build tool is operationally connectable to said hearing device for loading said image into said hearing device.

19. The system according to claim 14, wherein at least one of said software members comprises source code.

20. The system according to claim 14, wherein at least one of said software members comprises object code.

21. The system according to claim 14, wherein said selecting tool is adapted to at least one of:
checking the compatibility of the selected software members among each other;
checking the completeness of the selected software members; and
checking the compatibility of the selected software members with resources of said hearing device.

22. The system according to claim 14, wherein said selecting tool comprises a computer connectable to the internet and an computer program installed on said computer adapted to accessing the internet.

23. The system according to claim 14, wherein each of said software members of said subset represents a feature implementable in said hearing device.
